(19) United States
(12) Patent Application Publication
(10) Pub. No.: US 2007/0187873 A1
(43) Pub. Date: Aug. 16, 2007

(54) Cement-based, mesh reinforced concrete tiles with integral color and design

(76) Inventor: Wayne Edward Bailey, Fredericksburg, VA (US)

Correspondence Address: WAYNE E. BAILEY, P.O. BOX 3447, FREDERICKSBURG, VA, 22402, US

(21) Appl. No.: 11/354,648

(22) Filed: Feb. 16, 2006

(51) Int. Cl. B28B 3/00

(52) U.S. Cl. 264/333

(57) ABSTRACT

A method of manufacturing and installing cement-based concrete tiles, composed of portland cement, polymer-modified cement admixtures, sand, additional ingredients and color pigments integrated with reinforcement mesh for support and strength. The cement-based concrete mix may be dispersed and formed into a single layer cement-based concrete slab configuration with the reinforcement mesh completely embedded within. The cement-based concrete mix is distributed to achieve the desired texture, thickness and finish to form the cement-based concrete slab. After curing, any desired custom designs, engravings, additional colorations and wearing surface sealers are added to render the designs an embodiment of the cement-based concrete slab and thus an embodiment of the cement-based concrete tiles. The concrete slab is then cut into concrete tiles of custom dimensions. The cement-based concrete tiles are identified in sequential order to establish correct placement during the installation process. The custom cement-based concrete tiles may be from ⅛ inch thick to 2 inches thick, and may be installed on floors, walls, counter tops, interior, exterior and at any grade level using excepted professional installation procedure. The cement-based concrete tiles may be custom designed subject to the specifications of the end user.

### REFERENCES CITED

| | | |
|---|---|---|
| 5695811 | Dec., 09, 1997 | Anderson |
| 5162060 | Nov., 10, 1992 | Bredow |
| 5011903 | Apr., 30, 1991 | Lymburner |
| 5942300 | Aug., 24, 1999 | Lukowski |
| 6332941 | Dec., 25, 2001 | Council |
| 6167668 | Jan., 02, 2001 | Fine |
| 6379601 | Apr., 30, 2002 | Bowe |
| 4622257 | Nov., 11, 1986 | Thompson |
| 6568146 | May, 27, 2003 | Harvey |
| 6709717 | Mar., 23, 2004 | Mushovic |
| 5431962 | Jul., 11, 1995 | Glass |
| 4668548 | May, 26, 1987 | Lankard |
| 6682671 | Jan., 27, 2004 | Howell |
| 6372038 | Apr., 16, 2002 | Kameta |
| 5498683 | Mar., 12, 1996 | Kim |
| 4816503 | Mar., 28, 1989 | Cunningham |
| 4904711 | Feb., 27, 1990 | Sellstrom |
| 5927034 | Jul., 27, 1999 | Cole |
| 4349588 | Sep., 14, 1982 | Schiffer |
| 1204378 | Nov., 07, 1916 | Spencer |
| 5441677 | Aug., 15, 1995 | Phillips |
| 4177232 | Dec., 04, 1979 | Day |
| 4844964 | Jul., 04, 1989 | Jurrus |
| 5111627 | May, 12, 1992 | Brown |
| 6294768 | Sep., 25, 2001 | Liebich |
| 6684582 | Feb., 03, 2004 | Peart |
| 5997672 | Dec., 07, 1999 | Barr |
| 5406766 | Apr., 18, 1995 | Nichols |
| 5268028 | Dec., 07, 1993 | Fifield |
| 6387504 | May, 14, 2002 | Mushovic |
| 6161353 | Dec., 19, 2000 | Negola |
| 5085912 | Feb., 04, 1992 | Algiere |
| 4339289 | Jul., 13, 1982 | Lankard |
| 5666772 | Sep., 16, 1997 | Betty |
| 4195107 | Mar., 25, 1980 | Timm |

Disclosure Document Number: 589512, date: Nov., 07, 2005

### BACKGROUND OF THE INVENTION

The invention relates to a ⅛ inch to a 2 inch cement-based concrete tile that may be manufactured by spreading a designed polymer-modified Portland cement mix containing additives and admixtures in measured quantities over a reinforcement mesh. The function of the reinforcement mesh is to add support and strength to the cement-based concrete tile. The reinforcement mesh and the designed cement-based concrete mix are integrated to enable the cement-based concrete tile to be manufactured using a single layer spreading technique thus eliminating the need for laminated layers of cement-based concrete mix. The manufacturing and design process may performed in a studio or manufacturing facility.

The cement-based concrete mix formulas and the reinforcement mesh sizes may be modified to meet custom specifications. The cement-based concrete tiles may be custom designed and specified by the end user in terms of integral colors, textures, graphics, motifs, designs and dimensions.

Heretofore, the installation of tiles for floors and walls were mostly limited to designs, textures colors that were mass produced in large quantities with selections of designs, textures and colors being chosen by the manufacturing company, and not by the end user.

Heretofore, any attempt to deliver a tile manufactured from concrete meant that the tile may be of substantial thickness to maintain structural and tensile strength. The greater thickness added weight which increased freight, handling and installation costs as well as load restrictions in many buildings, thus often making a concrete tile impractical. The greater thickness of the concrete tile also created problems where raising the floor elevation causing architectural design problems.

Heretofore, usually the end user of a concrete tile is not offered the option to incorporate their own designs, textures, colors and specifications in the finished concrete tile.

Heretofore if a end user did specify a customized concrete floor, wall or counter top project to be totally produced at the job site, it could require weeks or months to complete. In construction or remolding projects it is often difficult to reserve or secure the designated work area due to other working tradesmen and material storage that may occupy the very space needed to properly complete a custom project, thus compromising the quality of the finished product. Other problems with trying to produce job site custom floor and wall design work, to list a few, is the lack of proper lighting, limited climate control, dust and dirt contamination, inadequate electric power and access to clean water. Trying to produce floor or wall designs on the job location in a occupied construction site may render less then ideal results. These production issues are much better controlled and managed if the cement-based concrete tiles are designed and produced in a off site design studio or manufacturing facility and then transferred to the job site to be installed.

This invention may solve many of the issues of other thicker and heavier mass produced concrete tiles by combining formulated cement mixes with selected sizes of reinforcement mesh to produce a thinner and lighter cement-based concrete tile with thicknesses from ⅛ inch to 2 inches and with custom designs, textures and colors chosen by the end user.

### SUMMERY OF THE INVENTION

It is the object of the invention to manufacture and install a cement-based concrete tile that is manufactured using designed cement formulas combined with reinforcement mesh that allows for cement-based concrete tiles to be between ⅛ inch thick and 2 inches thick. Integrated colors, textures and designs are subject to the custom specifications of the end user or manufacturer. The manufacturing process consists of distributing a single layer of specified cement-based concrete mix over and embedding a specified reinforcement mesh with a selected thickness of cement mix remaining above the reinforcement mesh to serve as the wear surface of the cement-based concrete slab. The addition of custom designs, engravings and colorations serve to be embedded with multiply coats of specified wear surface sealer thus rendering the design and sealer an integral part of the cement-based concrete slab. The cement-based concrete slab is then cut and divided into custom shaped cement-based concrete tiles to meet the specifications of the end user or the manufacturer. The individual cement-based concrete tiles are identified in sequential order so as to allow installation in the same and proper order as manufactured. The cement-based concrete tiles are installed using accepted professional installation procedures. The cement-based concrete tiles may be installed on floors, walls or countertops. The cement-based concrete tiles may be installed interior, exterior, above grade, on grade or below grade.

### BRIEF DESCRIPTION OF THE DRAWINGS

FIG. 1 illustrates the overall process for manufacturing the monolithic cement based concrete slab.

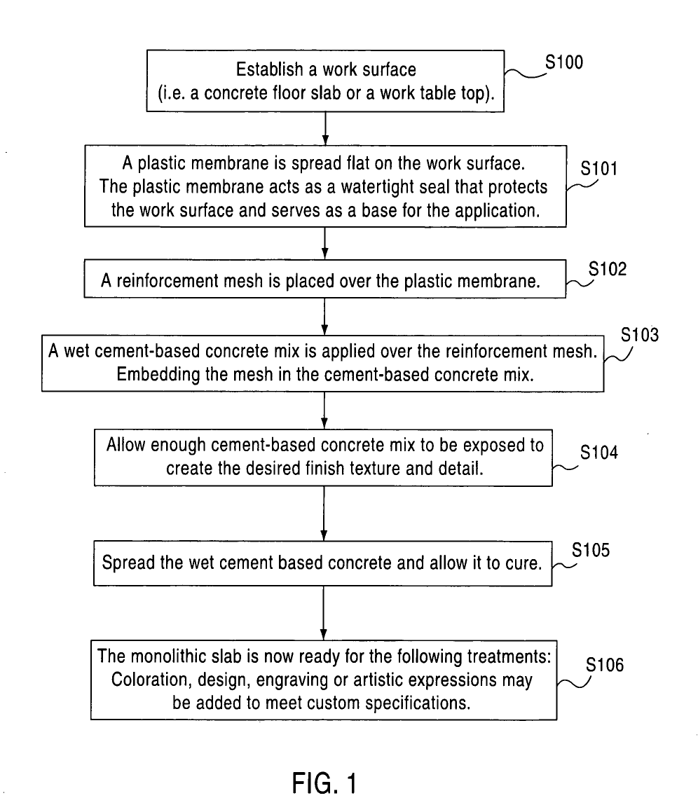

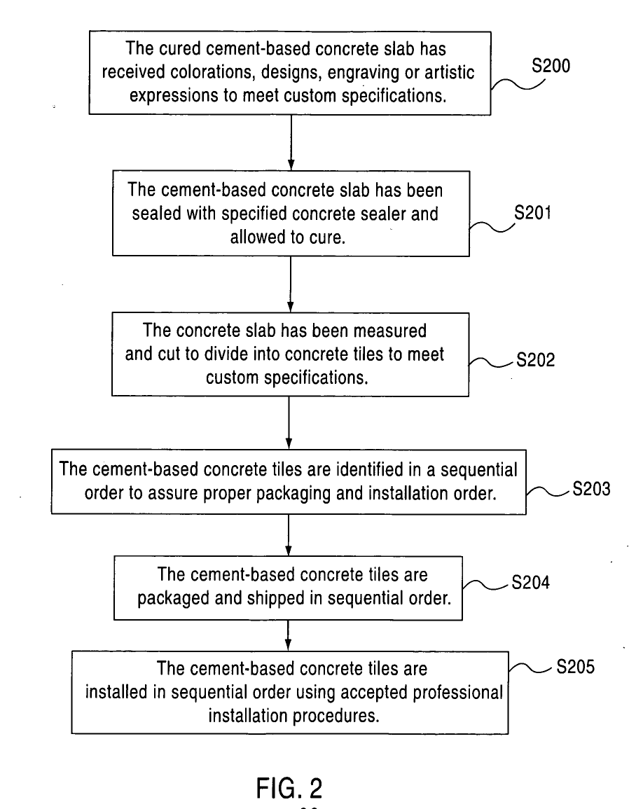

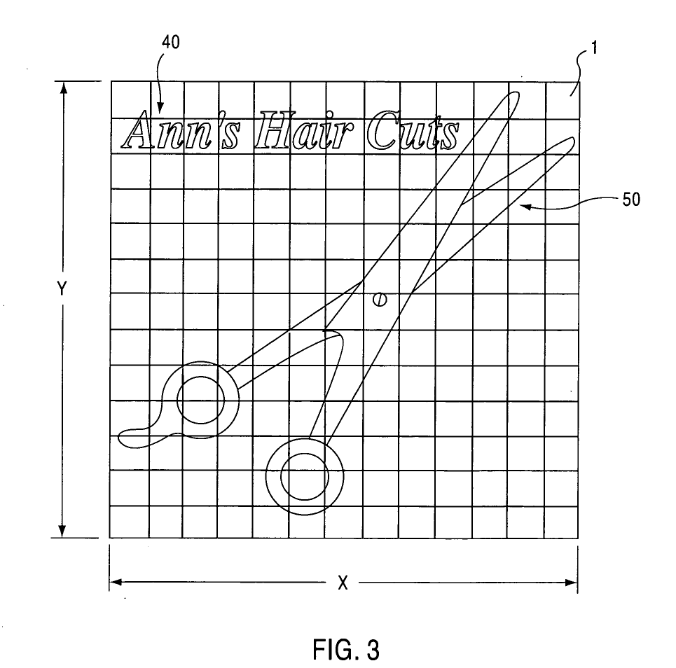

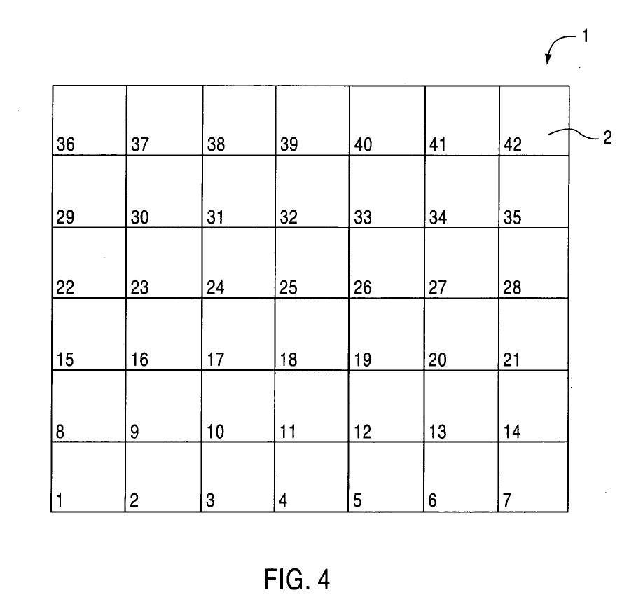

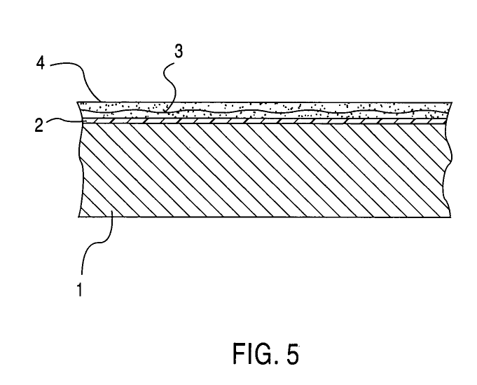

S 100 describes a step of the manufacturing process that establishes a solid base to serve as a work surface to be in the nature of a platform, table top or floor surface to support all components and materials necessary for the cement based concrete slab manufacturing process.

S 101 describes another step of the manufacturing process of the placement of a watertight membrane that may be in the form of a plastic sheet, which is to be laid flat and smooth upon the work surface S 100 so as to protect the work surface from contact of the cement-based concrete mix and serve as the base of the cement-based concrete mix during the manufacturing process, and to be removable after proper curing of the cement-based concrete tiles.

S 102 describes another step of the manufacturing process of the placement of the reinforcement mesh which is placed directly over, but not connected to the plastic membrane S 101 in a flat and monolithic configuration to become an internial component of the cement-based concrete slab.

S 103 describes another step of the manufacturing process of the placement of the wet cement-based concrete mix onto the reinforcement mesh S 102 in sufficient quantities so as to surround and embed the reinforcement mesh resulting in a monolithic cement-based concrete slab.

S 104 describes another step of the manufacturing process of the placement of the wet cement-based concrete mix onto the reinforcement mesh S 102 in sufficient quantities so as to cover the reinforcement mesh with a adequate amount and thickness of cement-based concrete mix so as to allow varying custom thicknesses and texture designs to be incorporated into the monolithic cement-based concrete slab.

S 105 describes another step in the manufacturing process of the placement, distribution and spreading process of the wet cement-based concrete mix S 103 in a manner so as to produce the desired style, thickness and finish, after which the cement-based concrete mix is allowed to dry to the state of being cured to become the cement-based concrete slab.

S 106 describes another step in the manufacturing process of the curing stage of the monolithic cement-based concrete slab, which is now ready to accept custom designs in the form of colorations, engravings, textures and artistic expressions to meet the end users specifications.

FIG. 2 illustrates the continuing steps of the manufacturing process of transforming the monolithic cement-based concrete slab into custom designed cement-based concrete tiles and identifying the tiles in sequential order for packaging, shipping and installation.

S 200 describes another step of the manufacturing process where-in the cement-based concrete slab S 106 has received the desired custom designs, engravings and artistic expressions and allowed to complete the curing process of such enhancements, rendering them as part of the cement-based concrete slab.

S 201 describes another step of the manufacturing process of sealing the cement-based concrete slab S 200 with a specified concrete sealer, allowing the sealer to cure rendering the sealer as part of the cement-based concrete slab.

S 202 describes another step of the manufacturing process of measuring and cutting the cement-based concrete slab S 201 into the custom sizes and shapes to produce the cement-based concrete tiles to meet the end-user specifications.

S 203 describes another step of the manufacturing process of identifying each individual cement-based concrete tile S 202 in the sequential order as manufactured S 200 so as to assure proper packaging and installation in the same identical order as manufactured.

S 204 describes another step of the manufacturing process of packaging and shipping the cement-based concrete tiles S 202 in the sequential order as manufactured S 200.

S 205 describes another step of the manufacturing process of installing the custom cement-based concrete tiles in the sequential order as manufactured S 203 using accepted professional installation procedures.

FIG. 3 describes another step of the manufacturing process wherein this particular sample of the cement-based concrete tiles are manufactured to the dimensions of Y and X, as specified by the end user.

FIG. 3 describes another step of the manufacturing process in which this particular cement-based concrete slab has been measured and cut into 169 square tiles of equal dimensions.

FIG. 3 describes another step of the manufacturing process wherein this particular sample illustrates one of the 169 cement-based concrete tiles, 1.

FIG. 3 describes another step of the manufacturing process wherein this particular sample illustrates two custom logos installed into the cement-based concrete tiles, 40 and 50. FIG. 4 describes another step of the manufacturing process wherein this particular sample illustrates a cement-based concrete slab that has been measured and cut into 42 equal tiles, 1. In this sample the end user specified a single color style.

FIG. 4 describes another step of the manufacturing process wherein this particular sample illustrates tile number 42 as one of the cut cement-based concrete tiles, 2.

FIG. 4 describes another step of the manufacturing process wherein this particular sample illustrates the sequential identification order of the manufactured cement-based concrete tiles, 1 thru 42, which serves to assure a matching sequential packaging and installation order to further assure continuity of the installed tiles.

FIG. 5 describes another step of the manufacturing process, illustrating a cross section of the work surface 1, which serves as the working base on which the plastic sheet 2, is installed to serve as a temporary watertight separation membrane and base for the reinforcement mesh 3 and the cement-based concrete mix 4 . Directly above the plastic membrane the reinforcement mesh 3, is installed, which serves as reinforcement, which will be embedded by the cement-based concrete mix 4, which when cured becomes the cement-based concrete slab and further, when cut into sections, becomes the cement-based concrete tile.

### DESCRIPTION OF THE PREFERRED EMBODIMENT

Cement design formulas have included admixtures and additives to produce different results for different concrete applications, however cement-based concrete tiles have proven to be difficult to produce. The subject invention consist of a cement mix design intergrated with reinforcement mesh that when combined, allows for the manufacturing of cement-based concrete tiles with high compression, tinsel and flexural strength. The features of integral colorations, custom art designs and engravings that are embedded within applied coats of wear surface sealer produce a unique cement-based concrete tile and installation of such.

Part (A), of the cement-based concrete tile manufacturing process, is the blending of the cement-based concrete mix design which may contain, among other ingredients, Portland cement (type I or type III) of white or gray color. Latex polymers, sand, glass micro spheres, lime stone powder or dust, quartz, clear or colored granulated glass, aluminum oxide, iron oxide pigments, liquid tints and pigments. The ingredients may be dry blended and then added to measured amounts of clean water. The cement-based concrete mix design formula may be adjusted for different cement-based concrete tile thicknesses, and specifications.

Part (B), of the cement-based concrete tile manufacturing process, is the reinforcement mesh, which may be in the form of scrim cloth, screen, mesh, lath, netting or other porous fabrics or webbing. The reinforcement mesh may be manufactured of fiber-glass, aluminum, plastic, metal, vinyl, polyester, urethane or steel using different thicknesses and gauges for different cement-based concrete tile thicknesses and specifications. The reinforcement mesh may be of a ridged design or of a flexible design for different cement-based concrete tile thicknesses and specifications. A thicker, more ridged reinforcement mesh may be used to manufacture thicker and stiffer cement-based concrete tiles. A thinner, more flexible reinforcement mesh may be used to manufacture a thinner and more flexible cement-based concrete tile.

Part ©), of the cement-based concrete tile manufacturing process, is a work surface or base which may be a flat floor area or any suitable flat surface located in a manufacturing or studio type facility. This work surface serves as the base and support for the manufacturing process.

Part (D), of the cement-based concrete tile manufacturing process, is the placement over the work surface of the water-tight membrane. The membrane may be a plastic sheet or a similarly constructed non-bonding membrane which serves as a water tight layer of separation of the work surface from the reinforcement mesh and the cement-based concrete mix. The water-tight membrane is to be placed in a flat and wrinkle free configuration. The water-tight membrane will be separated from the cement-based concrete tile after the tiles curing process is complete and before the tiles are installed.

Part (E), of the cement-based concrete tile manufacturing process, is the installation of the reinforcement mesh, Part (B), which is placed onto but not attached to the water-tight membrane, Part (D), the reinforcement mesh is placed in a flat and wrinkle free configuration. The reinforcement mesh serves to add strength and support to the cement-based concrete tile. The choice of a more rigid and thicker reinforcement mesh is used when a thicker and stiffer cement-based concrete tile is specified, and a more flexible and thinner reinforcement mesh is used when a more flexible and thinner cement-based concrete tile is specified.

Part (F), of the cement-based concrete tile manufacturing process, is the mixing of the blended ingredients, Part (A), with the water to produce the cement-based concrete mix, which will be distributed onto, around, through and under the reinforcement mesh, Part (B), and serve to embed the reinforcement mesh and come to rest on the plastic membrane, Part (D). Sufficient amounts of cement-based concrete mix will be applied so as to create no less then 1/16″ coverage above the top surface of the reinforcement mesh of the thinnest cement-based concrete tiles. Thicker cement-based concrete tiles will contain thicker amounts of cement-based concrete mix above the reinforcement mesh and will serve to be the wear surface after curing.

Part (G), of the cement-based concrete tile manufacturing process, is the formation of the cement-based concrete slab. The concrete slab may be as small as 1 feet by 1 feet dimensions or smaller and as large as 100 feet by 100 feet dimensions or larger with a thickness from ⅛ inch to 2 inches. The sizes and thicknesses of the concrete slabs are subject to the design specifications of the cement-based concrete tiles. The cement-based concrete tile thickness and dimensions are dictated by the end user or manufacturer specifications. Whatever the size and thickness of the cement-based concrete slab may be, there will be a work surface, Part ©), plastic membrane, Part (D), and reinforcement mesh, Part (B), representing the total area of the cement-based concrete slab. The reinforcement mesh will be imbedded by the placement and distribution of the cement-based concrete mix onto the reinforcement mesh. The cement-based concrete mix will have such viscosity as to flow through, around, under and over the reinforcement mesh rendering it to be embedded. A minimum of 1/16″ of cement-based concrete mix will be distributed and remain above the reinforcement mesh to serve as the wear and decorative surface of the cement-based concrete tile. An individual cement-based concrete slab cut into specified cement-based concrete tiles represents a particular individual cement-based concrete tile project.

Part (H), of the cement-based concrete tile manufacturing process, may be the troweling and distribution of the cement-based concrete mix over, through, under and around the reinforcement mesh to produce the cement-based concrete slab, Part (G), and rendering the slab to be of particular thickness, color, texture and style, as designated by the end user or manufacturers specifications. Using the single layer, non-laminated application technique, the cement-based concrete mix may be spread or applied using different tools and procedures, such as sprayers, rakes trowels, brushes, or screeds to produce the desired texture, thicknesses and finish. The cement-based concrete slab may be manufactured by the placement of the cement-based concrete mix in a continuous application and distributing action, using a wet cement to wet cement placement technique, so as to produce a slab of monolithic nature.

Part (I), of the cement-based concrete tile manufacturing process, is the drying and curing stage of the cement-based concrete slab, Part (G). Through the control of temperature, humidity and environment of the manufacturing or studio facility, the cement-based concrete slab curing process may be advanced.

Part (J), of the cement-based concrete tile manufacturing process, may be the application to the cured cement-based concrete slab, (G), of the custom art designs, impressions, graphic designs, engravings, paintings, staining and individual artistic applications that serve to render messages, advertising, logos, identifying statements, phrases, motifs, paintings, reproductions and any other designs, specified by the end user or manufacturer. The art work may cover any portion of the cement-based concrete slab, conversely the cement-based concrete slab may also be ordinary in style, without custom design work, all subject to the end user or manufacturer specifications. All art applications will be allowed to dry and cure completly.

Part (K), of the cement-based concrete tile manufacturing process, may be the application of one or more coats of the wear surface sealer. The sealer serves to be a protective shield and reinforce the durability of the cement-based concrete tile wear surface, with its embedded art designs, Part (J). The wear surface sealer also may serve to modify or emphasize the cement-based concrete tile wear surface by rendering different hues of color, different degrees of luster, gloss, brilliance or sheen. The final coat of wear surface sealer may also serve to be a sacrificial wear coat, to be reapplied, if worn away, to protect the cement-based concrete tile, and its embedded art design. The sealer may be solvent based or water based and sealer specifications may be specified by the end user or manufacturer. Additives may be added to the sealer to achieve a specific appearance or enhance the wear-ability or anti-slip qualities of the cement-based concrete tile. The sealer installation may be of multi-layers, which may result in multi-thicknesses of the wear surface sealer. The sealer must be allowed to completely dry and cure.

Part (L), of the cement-based concrete tile manufacturing process, may be the cutting and dividing of the cement-based concrete slab, Part (G), into the desired custom cement-based concrete tile dimensions and shapes as specified by the end user. The excepted technique for cutting the cement-based concrete tiles into the desired size and shape is the diamond blade saw, designed for concrete sawing. The width of the concrete diamond blade will dictate the amount of material being removed from the cement-based concrete slab in the form of concrete dust. The void or joint that is created as a result of the passing blade will be duplicated by spacing the cement-based concrete tiles the same width during the installation process in order to maintain the trueness of the tile dimensions and art work. The joint may become part of the tile design and installation. The joints may be grouted using accepted tile installation procedures, subject to the specifications of the end user or manufacturer. If, on the other hand, the obvious joints are deemed undesirable, then the tile cutting process would be performed and the tile edges would be abutted before the art design is applied, Part(J), thus a tight fit tile installation would render the art design to be coherent.

Part (M), of the cement-based concrete tile manufacturing process, may be the sequential identification or numbering system applied to the individual cement-based concrete tiles. Because each individual cement-based concrete tile is artistically unique and an individual member of the total family unit of tiles of the cement-based concrete tile project, they are to be installed using the same layout as used during the manufacturing and design, process, Part (J). A sequential identification system may be implemented to assure proper tile placement in relationship to the other tiles which make up the whole cement-based concrete tile project.

Part (N), of the cement-based concrete tile manufacturing process, may be the installation of the tiles that make up the cement-based concrete tile project. Because the cement-based concrete tiles may be as thin as ⅛″ in thickness or as thick as 2″,the tiles may be manufactured to be versatile for many types of installations and solve many architecture issues that require custom design solutions.

The cement-based concrete tiles may be installed using cement based mastic, or installed dry, without mastic or the cement-based tiles may be installed using other accepted professional tile installation procedures. The cement-based concrete tiles may be installed as a covering for floors, walls and counter tops, interior and exterior. The cement-based concrete tiles may serve to overlay and be the overlay component of a embedded radiant floor heating system. The cement-based concrete tiles may be installed above grade, on grade and below grade.

Part (O), of the cement-based concrete tile manufacturing and installation process may be the emphasis to design each individual cement-based concrete tile project to be a custom project with unique design features. The custom designs may be subject to the specifications of the end user, or the end users representative, or the custom designs may be subject to the specifications of the manufacturer. The cement-based concrete titles may be of custom design and considered to be unique.

I claim:

1). A method of manufacturing a cement-based concrete tile, which may consist of cement-based concrete mix placed over reinforcement mesh and distributed to become a cement-based concrete slab configuration, incorporating colors, design applications and wear surface sealers, then cut and divided into cement-based concrete tiles. The tiles may be installed in the identical sequential order as manufactured. The cement-based concrete tile designs may be of different colors, dimensions, thickness, textures, styles and designs embedded with wear surface sealers, subject to the custom specifications of the end-user or the manufacturer. The cement-based tiles may be installed on floors, walls, counter tops, exterior and interior applications on any grade level using excepted professional installation procedures. Any number of cement-based concrete tiles derived from a cement-based concrete slab may constitute a cement-based concrete tile project with custom design features.

2). A method of manufacturing the cement-based concrete tile may be:
a. Establish a work surface in a studio or manufacturing facility
b. Install a membrane to serve to protect and separate the work surface from the reinforcement mesh and the cement-based concrete mix.
c. Install the reinforcement mesh over, but not attached to the membrane.
d. Place and distribute the cement-based concrete mix over through, around and under the reinforcement mesh to manufacturer a cement-based concrete slab.
e. Distribute the cement-based concrete mix in single layer, non laminated application process with a wet to wet technique, so as to produce a monolithic cement-based concrete slab.
e. Distribute the wet cement-based concrete mix to develop textures, thicknesses, colors, styles and designs to manufacture a cement-based concrete slab.
f. The cured cement-based concrete slab may receive additional coloration and artistic designs, subject to end-user specifications or manufacturer specifications.
g. The cured cement-based concrete slab may receive one or more applications of wear surface sealer.
h. The cured cement-based concrete slab may be cut and divided into cement-based concrete tiles, subject to end-user or manufacturer specifications.
i. The cement-based concrete tiles may be identified in sequential order as manufactured so as to allow for identical placement and installation.
j. The cement-based concrete tiles may be installed in the same order as manufactured.

3). A method of installing the sequential identified cement-based concrete tile may be:
a. The cement-based concrete tile may be installed on floors, walls or counter tops.
b. The cement-based concrete tiles may be installed to exterior and interior surfaces.
c. The cement-based concrete tiles may be installed above grade, on grade and below grade.
d. The cement-based concrete tile may be installed using standard professional procedures.

4). A method of manufacturing, wherein the cement-based concrete tile textures, colors, dimensions, thicknesses and design specifications may be a integral part of the invention.

5). A method of manufacturing a cement-based concrete tile, where-in cement mix formulas, reinforcement mesh and wear surface sealer specifications may be a integral part of the invention

6). A method as defined in claim 1, wherein the cement-based concrete mix may contain, among other ingredients the following:
a. Measured amounts of Portland cement, type I or type III, gray or white, that may contain, among other ingredients the following:
1.) Tricalcium silicate
2.) Dicalcium silicate
3.) Tricalcium aluminate
4.) Tetracalcium aluminoferrite
5.) Calcium sulfate
b. Measured amounts of quartz sand graded, dried, sifted and sized from 0.063 mm to 5 mm
c. Measured amounts of specified aggregate, sized from 0.063 mm to 30 mm.
d. Measured amounts of redispersible polymer powder that may contain among other ingredients, vinyl acetate-ethyiene or acetate-versatate copolymers or vinyl acetate.
e. Measured amounts of limestone powder sized from 0.063 mm to 10 mm.
f. Measured amounts of ceramic/glass micro spheres sized from 0.063 mm to 10 mm
g. Measured amounts of clear or colored granulated glass from 0.063 mm to 10 mm
h. Measured amounts of Aluminum Oxide, sized from 0.063 mm to 10 mm
i. Measured amounts of dry iron oxide pigments in powder form, natural and synthetic metal oxides.
j. Measured amounts of liquid water based pigments.
k. Measured amounts of clean water.

7). A method as defined in claim 1, wherein the measured amounts of dry ingredients may be blended and then added to measured amounts of clean water in addition to any liquid admixtures that may be specified and then mixed, resulting in a homogenous cement-based concrete mix.

8). A method as defined in claim 1, wherein the adjusted formulas and mix designs of the cement-based concrete mix is of such flexural, tinsel, and compression strength as to allow concrete tile thicknesses to be manufactured from as thin as ⅛ inch and to as thick as 2 inches.

9). A method as defined in claim 1, wherein the different formulas of the cement-based concrete tile may be of such mix design, that when manufactured in the thinner thicknesses may be more flexible in nature and when manufactured in thicker thicknesses may be more ridged in nature.

10). A method as defined in claim 1, wherein the cement-based concrete mix design may include color pigments and tints for producing integrally colored cement-based concrete tiles, subject to cement-based concrete tile design specifications.

11). A method as defined in claim 1, wherein a reinforcement mesh may be an integral part of the cement-based concrete tile. The reinforcement mesh serves to strengthen and add support to the cement-based concrete tile.

12). A method as defined in claim 1, wherein reinforcement mesh may be in the form of any of the following, subject to cement-based concrete tile design specifications
a. Scrim cloth
b. Screen
c. Mesh
d. Lath
e. Netting
f. Fabric
g. Webbing

13). A method as defined in claim 1, wherein reinforcement mesh may be manufactured from any of the following, subject to cement-based concrete tile design specifications.
a. Fiberglass
b. Steel
c. Plastic
d. Vinyl
e. Aluminum
f. Metal
g. Polyester
h. Nylon
i. Coated yam
j. Bronze
k. Stainless Steel
l. PVC-Coated fiberglass

14). A method as defined in claim 1, wherein the reinforcement mesh may be sized and gaged from 1/16 inch to 1 inch, and positioned within the body of the cement-based concrete tile and no closer then 1/16 inch from the top surface of the cement-based concrete tile, subject to cement-based concrete tile design specifications.

15). A method as defined in claim 1, wherein the reinforcement mesh sieve dimensions may be sized from 1/32 inch to 1 inch, subject to cement-based concrete tile design specifications.

16). A method as defined in claim 1, wherein the reinforcement mesh may be more of a ridged design or more of a flexible design, subject to cement-based concrete tile design specifications.

17). A method as defined in claim 1, wherein the cement-based concrete slab dimension may be 12 inches by 12 inches or smaller and as large as 100 feet by 100 feet or larger.

18). A method of manufacturing, wherein the cement-based concrete slab may be manufactured in a studio or manufacturing facility.

19). A method of manufacturing, wherein the cement-based concrete slab may be manufactured on a flat work surface which is the base and support for the manufacturing process.

20). A method of manufacturing, wherein a watertight plastic membrane is installed over the work surface to act as a separator and to prevent the reinforcement mesh and cement-based concrete mix from coming in contact with the work surface.

21). A method as defined in claim 20, wherein the plastic membrane may be designed to be non-bonding and to prevent the reinforcement mesh and cement-based cement mix from making contact with the work surface. The plastic membrane is extended out horizontally over a flat and solid work surface to perform the following:
a. Serve to be manufactured of a non-porous plastic sheet or like substance.
b. Serve to lay flat and wrinkle free under the total area of the flexible reinforcement mesh.
c. Serve as a membrane upon which the reinforcement mesh is placed, but not attached.
d. Serve as a water proof barrier between the work surface and the cement based concrete mix.
e. Serve to allow for a smooth and flat under-side of the cement-based concrete tile.
f. Serve to be removable from the under side of the cured and cut cement-based concrete tile.
g. Serve to be removed from the cement-based concrete tile before installation.
h. Serve to be rendered unuseable and properly disposed of once removed from the underside of the cement-based concrete tile.

22). A method as defined in claim 1, wherein the reinforcement mesh may be placed onto, but not attached to the previously placed plastic membrane to perform the following:
a. Serve to be manufactured in larger dimensions resulting in minimum number of seams.
b. Serve to be manufactured and both flexible and rigid designs in nature.
c. Serve to be installed in a horizontal and flat like profile, with no wrinkles over the previously installed plastic membrane.
d. Serve to be installed flat and embedded with the cement based concrete mix.
e. Serve to be installed in a flat like profile so as to be completely covered by the cement-based concrete mix.
f. Serve to be embedded completely with the cement-based concrete mix, thus allowing the cement-based concrete mix to flow through, around and under.
g. Serve to be embedded beneath the top surface of the cement-based concrete mix by no less then 1/16 inch during the cement-based cement mix placement stage of the manufacturing process.
h. Serve to be embedded beneath the top surface of the cement-based concrete tile by no less then 1/16 inch after the curing stage is complete.
i. Serve as the embedded reinforcement support to absorb tensile and shearing stresses to the cement-based concrete tile.
j. Serve as the embedded reinforcement to support and strengthen the cement-based concrete tile.

23). A method of manufacturing, wherein the design of the cement-based concrete mix may be of the proper viscosity for flowing over, through and around the reinforcement mesh, allowing the reinforcement mesh to become fully embedded into the cement-based concrete mix.

24). A method as defined in claim 1, wherein the cement-based concrete mix may be distributed on to the surface of the reinforcement mesh in sufficient quantities so as to produce a wear surface above the reinforcement mesh of a minimum 1/16 inch thickness. The mix may be applied using a single layer, non-laminated, wet cement to wet cement placement technique, resulting in a monolithic concrete slab.

25). A method as defined in claim 1, wherein the cement-based concrete mix may be distributed over the reinforcement mesh area to produce the cement-based concrete slab, using, but not limited to any of the following techniques, subject to cement-based concrete tile design specifications.
a. Troweling by hand or machine
b. Spraying
c. Raking
d. Brooming or brushing
g. Rolling
h. Vibrating

26). A method as defined in claim 25, wherein the cement-based concrete mix may be applied using different techniques leaving a minimum thickness of 1/16 inch of cement-based concrete mix covering the reinforcement mesh.

27). A method as defined in claim 25, wherein the thickness of the cement-based concrete slab between the upper surface of the reinforcement mesh and through the upper surface of the concrete slab may be no less then 1/16 inch and is refereed to as the wear surface and design surface.

28). A method as defined in claim 1, wherein custom designs, colors, textures, impressions and artistic expressions may be incorporated into the portion of the cement-based concrete slab between the reinforcement mesh and the upper surface of the cement-based concrete slab creating integrally placed designs and colors beneath protective coats of sealers by using any of the following techniques, subject to cement-based concrete tile design specifications.
a. Brushing
b. Texturing
c. Staining
d. Engraving
e. Rolling
f. Painting
g. Vibration
h. Application of sealers
i. Projection stenciling
j. Etching
k. Stenciling
l. Inlaying
m. Air Brushing
n. Grinding
o. Free art
p. Impressionism

29). A method as defined in claim 1, wherein murals, custom designs, identification trademarks, identification colors, labyrinths, phraseologies, custom art, artistic reproductions and expressions are created into and onto the concrete slab and becomes an internial component of the cement-based concrete slab when the wear surface is covered with sealers, epoxies, urethane or similar protective coatings.

30). A method as defined in claim 1, wherein the final application of the cement-based concrete tile may be in the form of one or more coats of sealer, subject to the specifications of the end user or manufacturer.

31). A method as defined in claim 1, wherein the final layer of sealer may serve to be a sacrificial protective coat and serve to be replaceable and to be replaced when worn away.

32). A method as defined in claim 1, wherein the cement-based concrete tiles may be manufactured to be of custom design or of ordinary design. Colors, thicknesses, cement-based concrete tile mix formulas, textures, engravings, styles and artistic expressions may be subject to the specifications of the end user or manufacturer.

33). A method as defined in claim 1, wherein the cured cement-based concrete slab may be cut into cement-based concrete tiles, with dimensions and shapes subject to cement-based concrete tile design specifications by the end user or the manufacturer. The tile cutting process is by accepted professional techniques and tools.

34). A method as defined in claim 1, wherein the individual cement-based concrete tiles may be identified in sequential order as they are packaged for delivery in the same sequential order as they were manufactured.

35). A method as defined in claim 1, wherein the cement-based concrete tiles may be unpacked at the job site in the same sequential order as they were manufactured.

36). A method as defined in claim 1, wherein the cement-based concrete tiles may be installed in the same sequential order as they were manufactured.

37). A method as defined in claim 1, wherein the cement-based concrete tiles may be installed on floors, walls and counter tops.

38). A method as defined in claim 1, wherein the cement-based concrete tiles may be installed on a solid, and properly prepared substrate or sub-floor.

39). A method as defined in claim 1, wherein the cement-based concrete tiles may be installed in interior or exterior areas, above grade, on grade and below grade.

40). A method as defined in claim 1, wherein the cement-based concrete tiles may be installed with general tile mastic, cement-based tile adhesive or any product deemed satisfactory by professional tiling procedures.

41). A method of manufacturing, wherein the cement-based tiles may be installed to overlay floor radiant heat installations. The cement-based concrete tile may be a separate overlay of the floor radiant-heat system or considered a part of a floor radiant-heat system and its installation.

42). A method of manufacturing that allows that cement-based concrete tiles may form an individual project and may be designed to be a custom project which may be unique to other projects. The unique custom design of each cement-based concrete tile project may be subject to the specifications of the end user, the end users representative or to the specifications of the manufacturer. Each individual cement-based concrete tile project may be of a custom design so as to be considered unique.
